(19) United States
(12) Patent Application Publication
(10) Pub. No.: US 2014/0254896 A1
(43) Pub. Date: Sep. 11, 2014

(54) UNMANNED DRONE, ROBOT SYSTEM FOR DELIVERING MAIL, GOODS, HUMANOID SECURITY, CRISIS NEGOTIATION, MOBILE PAYMENTS, SMART HUMANOID MAILBOX AND WEARABLE PERSONAL EXOSKELETON HEAVY LOAD FLYING MACHINE

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 14/285,659

(22) Filed: May 23, 2014

Related U.S. Application Data
(63) Continuation-in-part of application No. 13/760,214, filed on Feb. 6, 2013.
Application No. 13/760,214 is a continuation-in-part of application No. 13/185,491, filed on Jul. 18, 2011.
Application No. 13/185,491 is a continuation-in-part of application No. 13/973,146, filed on Aug. 22, 2013.
Application No. 13/973,146 is a continuation-in-part of application No. 13/776,852, filed on Feb. 26, 2013.

(51) Int. Cl. B64D 1/08; B64C 27/10; B64C 27/20; B64C 19/00; G06Q 20/20; B25J 9/16; G06K 9/00; G06F 3/041; G06Q 20/38; G06Q 20/32; B25J 9/00; B64D 17/00

(52) U.S. Cl. CPC B64D 1/08; B25J 9/0006; B64C 27/10; B64C 27/20; B64C 19/00; B64D 17/00; B25J 9/16; B25J 9/1697; G06K 9/00013; G06F 3/041; G06Q 20/3829; G06Q 20/327; G06Q 20/209; Y10S 901/01
USPC 382/124; 258/1.2; 701/2; 244/17.23; 244/4 A; 244/23 A; 244/194; 701/28; 345/173; 705/71; 705/16; 705/24; 901/1

(57) ABSTRACT

Provided is a system and method for delivering mail and goods using a mobile robot drone system. The method may comprise self-moving the mobile robot drone system to a mail or goods receiving location. Data on the mail or goods receiving location and mail or goods to deliver id received from a user. Itinerary to the mail or goods receiving location is determined based on itinerary data received from a GPS unit. In the location, the mobile robot drone system receives the mail or goods via a mail and goods compartment and then delivers the mail or goods to a predefined location. Based on user instructions, the mobile robot drone system electronically signs receipt verification documents or performs payment by displaying a payment barcode encoding user payment information. After delivering the mail or goods, the mobile robot drone system provides access to the mail and goods compartment.

### CROSS-REFERENCE TO RELATED APPLICATIONS

This application is a continuation-in-part of U.S. patent application Ser. No. 13/185,491, entitled “FACILITATING MOBILE DEVICE PAYMENTS USING PRODUCT CODE SCANNING,” filed on Jul. 18, 2011, U.S. patent application Ser. No. 13/760,214, entitled “WEARABLE PERSONAL DIGITAL DEVICE FOR FACILITATING MOBILE DEVICE PAYMENTS AND PERSONAL USE,” filed on Feb. 6, 2013, U.S. patent application Ser. No. 13/973,146, entitled “WEARABLE AUGMENTED REALITY EYEGLASS COMMUNICATION DEVICE INCLUDING MOBILE PHONE AND MOBILE COMPUTING VIA VIRTUAL TOUCH SCREEN GESTURE CONTROL AND NEURON COMMAND,” filed on Aug. 22, 2013, U.S. patent application Ser. No. 13/776,852, entitled “WEARABLE PERSONAL DIGITAL FLEXIBLE CLOUD GAME, MULTIMEDIA, COMMUNICATION AND COMPUTING DEVICE,” filed on Feb. 26, 2013, which are incorporated herein by reference in their entirety.

### FIELD

This application relates generally to mobile robot drone systems and, more specifically, to mobile robot drone systems for delivering mail and goods capable of performing payments and electronically signing documents.

### BACKGROUND

Simple routine tasks like receiving and delivering mail, delivering purchases, or meeting a courier may be time-consuming and interfere with a planned order of the day.

Robots are widely used for automation of various tasks, such as delivering goods in a warehouse. However, goods delivery robots of this type are often guided by tracks or human-operated, and in most cases their ability to self-govern is limited.

Thus, conventional robots for delivery lack autonomy and task variability. Furthermore, they may be associated with high development and maintenance costs.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a mobile robot drone system for delivering mail and goods and a method for delivering mail and goods using the mobile robot drone system. The mobile robot drone system for delivering mail and goods may comprise a mail and goods compartment including an opening to receive mail and a lid to place and remove mail and goods. For moving, the mobile robot may have one or more driving motors coupled to moving means. Itinerary to reach a location, where the mobile robot may collect mail or goods, may be determined using a processor and a GPS unit. Additionally, the mobile robot drone system may comprise a memory unit communicatively coupled to the processor and configured to store at least payment data, purchase data, and the itinerary data. The data and/or various messages may be displayed on a screen coupled to the processor.

The mobile robot drone system may communicate with external devices via a communication circuit communicatively coupled to the processor. The communication circuit may include a Bluetooth module, a WiFi module, a communication port, including a universal serial bus (USB) port, a parallel port, an infrared transceiver port, a radiofrequency transceiver port, and so forth.

In some embodiments, communication with the mobile robot drone system may be performed via a screen, which may be a touchscreen enabling user interaction with the mobile robot drone system through touch. Alternatively, operation of functions of the mobile robot drone system may be controlled using one or more control elements.

In some embodiments, access to the mobile robot drone system and/or mail and goods compartment may be authorized. Authorization may include a password, a Personal Identification Number (PIN) code, voice authorization, biometric authorization, and so forth. The biometric authorization may be done by fingerprint scanning, palm scanning, face scanning, retina scanning, and the like. To perform scanning, the mobile robot drone system may comprise the one or more biometric sensors.

Biometric authorization may be based on comparing scanned biometric parameters of a person to reference biometric parameters of the user stored by the memory unit to recognize the user.

Additionally, the mobile robot drone system may comprise one or more solar cells disposed on an outer surface of the mobile robot drone system and configured to charge the mobile robot drone system. Alternatively, the mobile robot drone system may charge wirelessly using a wireless charger accessory.

In some embodiments, the mobile robot drone system may comprise a microphone. The microphone may sense voice data, such as a voice command, a voice memo, a voice message, and so forth. The voice data may be transmitted to the processor for processing and/or stored to the memory.

The voice data and/or other sound data (an audio recording, a sound signal, an alarm, and so forth) may be reproduced using an audio reproduction element. In such a way, the mobile robot drone system may record voice messages of the user and transmit them to people.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 illustrates an environment within which the mobile robot drone system and methods for delivering mail and goods using the mobile robot drone system can be implemented.

FIG. 2 illustrates an example of the mobile robot drone system, in accordance to some embodiments.

FIG. 3 is a flow chart illustrating a method for delivering mail and goods using a mobile robot drone system, in accordance with certain embodiments.

FIG. 4 shows the mobile robot drone system receiving mail with signature authorization, in accordance to some embodiments.

FIG. 5 shows the mobile robot drone system receiving goods with barcode payment, in accordance to some embodiments.

FIG. 6 shows the mobile robot drone system for receiving goods with a humanoid security robot and a coaxial copter, in accordance to some embodiments.

FIG. 7 shows detaching of the humanoid security robot from the coaxial copter for delivering mail or goods to the door of the receiver, in accordance to some embodiments.

FIG. 8 shows the mobile robot drone system for receiving goods with a humanoid security robot and a quadrocopter, in accordance to some embodiments.

FIG. 9 shows a personal exoskeleton, in accordance to some embodiments.

### DETAILED DESCRIPTION

A mobile robot drone system for delivering mail and goods and related methods are described herein. The mobile robot drone system may autonomously move to a delivery receiving location, receive goods or mail, and transport it back. The mobile robot drone system may independently determine an appropriate itinerary to reach the location where it will receive goods or a return itinerary where the mail or goods need to be delivered. In the delivery receiving location, mail or goods may be received using a mail and goods compartment of the mobile robot drone system. A postman or a salesperson may put mail and goods into the mail and goods compartment. Then, the mobile robot drone system may determine the return itinerary using a GPS unit and/or itinerary Odata provided by the user and move to the delivery destination.

In case of registered mail, the mobile robot drone system may be configured to wirelessly receive a receipt verification document, electronically sign the receipt verification document, and return the signed receipt verification document to a sender.

Additionally, the mobile robot drone system may pay for goods to be delivered by displaying a payment barcode on a screen. The payment barcode may encode financial information of the user (for example, card number of the user, expiration date, user name, and so forth). The payment barcode may be scanned by a barcode scanner, and the corresponding account may be charged.

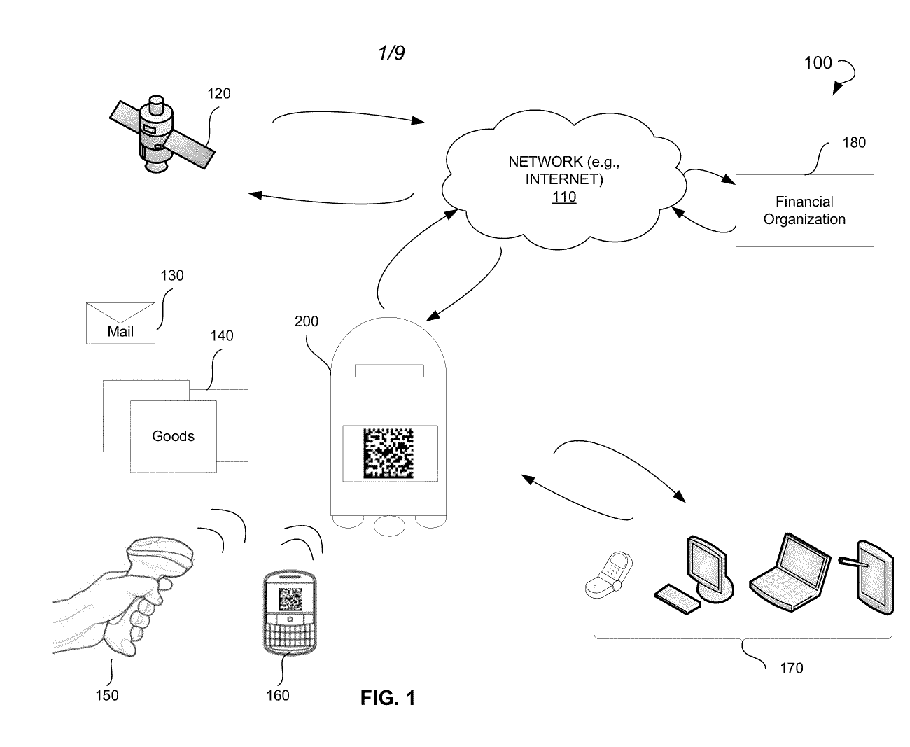

Referring now to the drawings, FIG. 1 illustrates an environment 100 within which the mobile robot drone system 200 and methods for delivering mail and goods using the mobile robot drone system 200 can be implemented. The environment 100 may include a network 110, the mobile robot drone system 200, a GSM satellite 120, one or more external devices 170, a mobile phone 160, a barcode scanner 150, and a financial organization 180. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication. The mobile robot drone system 200 may communicate with the GPS satellite via the network 110 to exchange data on a geographical location of the mobile robot drone system 200.

The mail 130 and/or goods 140 may be placed in the mail and goods compartment of the mobile robot drone system 200 to be delivered to a delivery destination.

As shown, the mobile robot drone system 200 may be configured to display a payment barcode scannable by the barcode scanner 150, or another suitable device, for example, the mobile phone 160. The mobile robot drone system 200 may communicate with the network 110 to communicate with the one or more external devices 170, retrieve information encoded in one or more barcodes, exchange data with the financial organization 180, and so forth. The one or more external devices 170 may include a mobile phone, a smartphone, a tablet PC, a lap top, a personal computer, a digital eyeglass device, and so forth. Communication with the one or more external devices 170 may be via the network 110 wirelessly or by wires using various connections such as a universal serial bus (USB) port, a parallel port, an infrared transceiver port, a radiofrequency transceiver port, and so forth. Such communication may be used to exchange or store data, manage data stored on the device, synchronize data. In some embodiments, the mobile robot drone system 200 may synchronize with the one or more external devices in real time to exchange data.

For the purposes of communication, the mobile robot drone system 200 may be compatible with one or more of the following network standards: GSM, CDMA, LTE, IMS, Universal Mobile Telecommunication System (UMTS), 4G, 5G, 6G and upper, RFID, and so forth.

In some embodiments, the mobile robot drone system may have an operating system executing on the processor. The operating system may include Android, iOS, Firefox OS, and other operating systems.

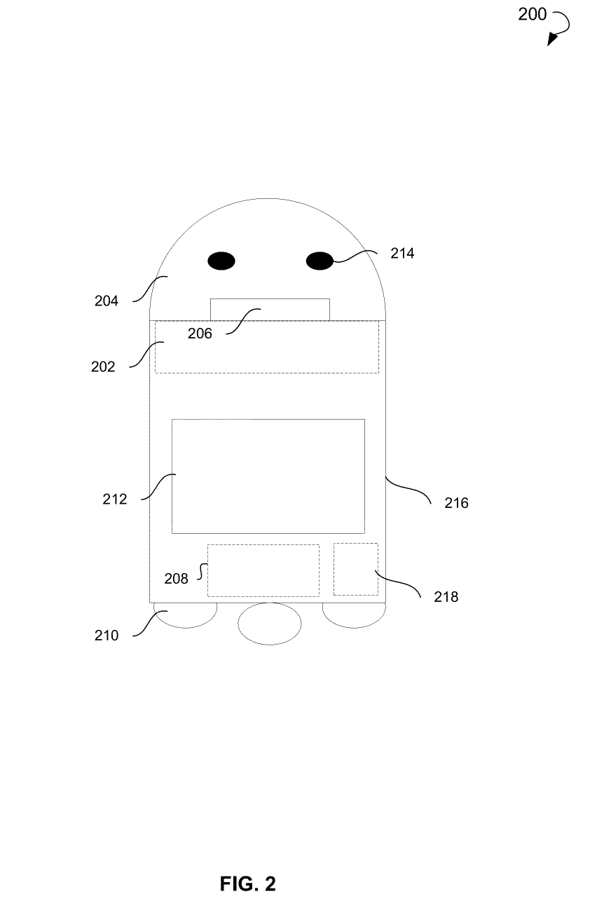

FIG. 2 illustrates an example of the mobile robot drone system 200 in accordance to some embodiments. The mobile robot drone system 200 may comprise a housing 216, which may enclose mail and goods compartment 202, one or more driving motors 208, a processor (not shown), a memory unit (not shown), a communication circuit (not shown), a screen 212, a camera 214, and a GPS module (not shown). The one or more driving motors 208 may be coupled to the moving means to drive and move the mobile robot drone system.

In some embodiments, the mobile robot drone system 200 may include a battery 218 providing energy to the one or more driving motors 208. The battery 218 may be charged externally, or using one or more solar cells disposed on an outer surface of the mobile robot drone system 200. The solar cells may be electrically connected to a battery of the mobile robot drone system 200 and may be configured to charge the battery. In other embodiments, the mobile robot drone system 200 may charge wirelessly using a wireless charger accessory.

The mail and goods compartment 202 may include an opening for mail 206 and a lid 204 for goods. The lid may open automatically to provide access to the mail and goods compartment 202.

In some embodiments, access to the mail and goods compartment 202 may be secured by various authorization means. For example, the mobile robot drone system 200 may comprise one or more biometric sensors to sense biometric parameters of the user. The sensed biometric parameters may be compared to reference biometric parameters of the user stored in the memory of the mobile robot drone system 200 to recognize the user.

Additionally, access to the mobile robot drone system 200 may be controlled by a password, a Personal Identification Number (PIN) code, biometric authorization, and so forth. The biometric authorization may include fingerprint scanning, palm scanning, face scanning, and retina scanning using the one or more biometric sensors and/or camera 214.

In some embodiments, fingerprint scanning may be performed using a fingerprint reader integrated in the mobile robot drone system 200 or detachably connected to the mobile robot drone system 200. The scanned fingerprint may be matched to one or more approved fingerprints stored in the memory of the mobile robot drone system 200. The access to the system may be granted if the scanned fingerprint matches one of the stored fingerprints, otherwise access may be denied.

The camera 214 may be disposed in the lid 204 and communicatively coupled to the processor.

The camera 214 may be configured to scan one or more barcodes. Barcodes captured by the camera 214 may be processed by the processor to retrieve barcode information. The barcodes may include invoice information to receive payment, street barcodes encoding data on street name and/or geographical location, and so forth.

The processor may be configured to control moving of the mobile robot drone system 200 based on a geographical location of the mobile robot drone system 200 and itinerary data. Data on the geographical location of the mobile robot drone system 200 may be received from the GPS module configured to track geographical location of the mobile robot drone system 200.

The memory unit may be communicatively coupled to the processor and configured to store at least payment data, purchase data, and itinerary data. Thus, the user may transmit data on his debit or credit card to the mobile robot drone system 200. The data may be transmitted, wirelessly or by wires, using the communication circuit communicatively coupled to the processor and configured to communicate with one or more external devices. The communication circuit may include one or more of the following: a Bluetooth module, a WiFi module, a communication port, including a universal serial bus (USB) port, a parallel port, an infrared transceiver port, a radiofrequency transceiver port.

Additionally, the user may transmit to the mobile robot drone system 200 data on the desired goods to be delivered, one or more messages to a postman and/or salesperson, identification data related to the mail or goods to be delivered, and so forth.

The payment data, purchase data, one or more messages, and so forth may be displayed on the screen of the 212 of the mobile robot drone system 200. In some embodiments, the screen may be a touchscreen configured to enable user interaction with the mobile robot drone system 200 through touch.

The mobile robot drone system 200 may further comprise one or more control elements to control operation or functions of the mobile robot drone system 200. The control elements may include buttons, switches, keys, and so forth.

Additionally, the mobile robot drone system 200 may comprise a microphone to sense voice data. The voice data may include a voice command, a voice memo, a voice message, and so forth. The voice data may be processed by the processor, stored to the memory unit, and/or reproduced when necessary using an audio reproduction element, for example, a speaker.

The mobile robot drone system 200 may reproduce voice messages stored in the memory unit, notifications, and/or other sound data. For example, the mobile robot drone system 200 may reproduce an audio recording, a sound signal, an alarm, and so forth.

In some embodiments, the processor may be further configured to generate, based on payment data, a payment barcode encoding the payment data; and display, based on predefined conditions, the payment barcode on the screen 212. The predefined conditions may be set by the user.

The displayed payment barcode may be scannable by a barcode scanned. After scanning, the payment data encoded in the barcode may be retrieved and the account associated with the payment data may be charged.

In some embodiments, the mobile robot drone system 200 may be further configured to download, install, and run applications, receive and send text, video, multimedia data, and perform other operations.

As stated, the mobile robot drone system 200 may have wireless communication capabilities enabled using at least the communication circuit. The communication circuit may be communicatively coupled to the processor and configured to communicate with one or more external devices via a network wirelessly of by wires using one or more of the following: a Bluetooth module, a WiFi module, the communication port 206, including a universal serial bus (USB) port, a parallel port, an infrared transceiver port, a radiofrequency transceiver port, and so forth. The mobile robot drone system 200 may have internet connectivity using cellular networks (e.g., 3G, 4G) as well as Wi-Fi and other types of networks. Some additional examples of such networks are GSM, CDMA, LTE, IMS, Universal Mobile Telecommunication System (UMTS), RFID, 4G, 5G, 6G and upper.

The mobile robot drone system 200 may further comprise an operating system executing on the processor. The operating system may include Android, iOS, Firefox OS, and so forth.

The mobile robot drone system 200 can be operated by operated by a remote device (not shown). The remote device can include one or more of the following: a wearable personal digital wrist watch device, a wearable augmented reality eyeglass communication device, a wearable personal digital flexible computing device, and so forth. The mobile robot drone system 200 can be operated using an application associated with a mobile device or a wearable device, such as a wearable personal digital wrist watch device, a wearable augmented reality eyeglass communication device, a wearable personal digital flexible computing device, and so forth. The mobile robot drone system 200 can be operated using a sophisticated GPS system to provide a peer-to-peer postal service.

In an example embodiment, the mobile robot drone system 200 may weight less than 25 pounds, 25 pounds, or more than 25 pounds.

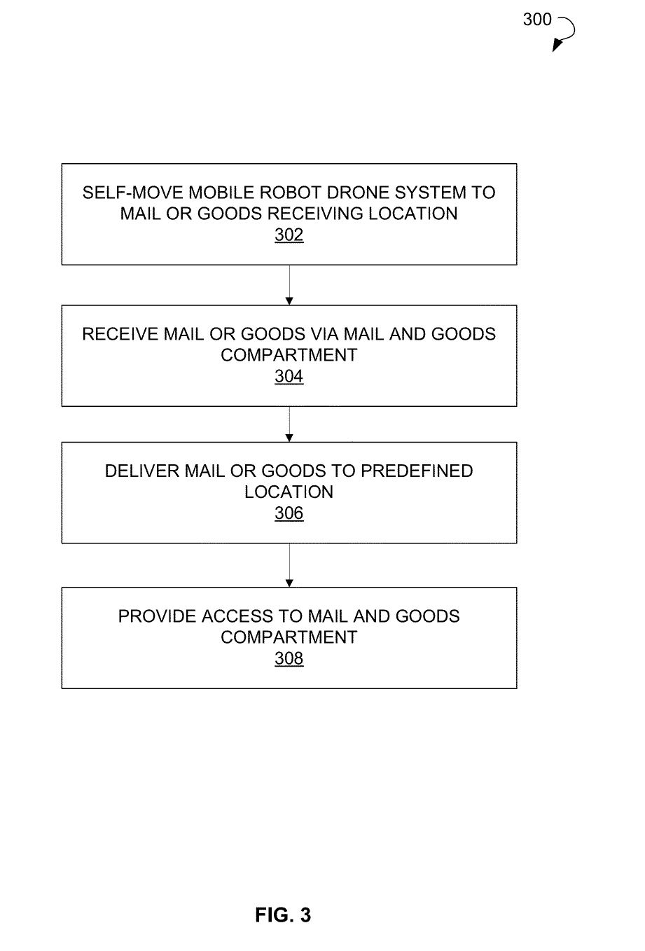

FIG. 3 is a flow chart illustrating a method 300 for delivering mail and goods using a mobile robot drone system, in accordance with certain embodiments. Method 300 may start with self-moving the mobile robot drone system to a mail or goods receiving location at operation 302. The location and/or request to deliver mail or goods may be received from a user. Based on the received location, the mobile robot drone system may determine itinerary using a GPS unit, itinerary data that may be received from the user, geographical maps, and so forth. Additionally, the user may provide information on mail or goods to be delivered, for example, name and address of the user, identification number of the mail, dispatch, or parcel, list of goods to be delivered, an order number, and so forth. The mobile robot drone system may be configured to stand motionless as a traditional mailbox, thus being a smart humanoid mailbox. The mobile robot drone system may have smart functions, humanoid functions, smart humanoid home security functions, and so forth.

Thus, the mobile robot drone system may move to the location autonomously based on the received data. Self-moving may be executed by one or more driving motors coupled to driving means. The driving means may include one or more wheels, one or more tracks, legs, and so forth. In some embodiments, the moving means may include an air cushion, a magnetic cushion, gravity moving system, and so forth.

When the mobile robot drone system arrives in the mail or goods receiving location, it may receive mail or goods via a mail and goods compartment at operation 304. The mail or goods may be put in the mail and goods compartment by a postman or a salesperson, or by a post robot system. To identify itself and/or inform the postman or salesperson about the mail or goods to receive, the mobile robot drone system may display corresponding data on the screen, make an audio signal, reproduce an audio message, reproduce a video message, and so forth. In some embodiments, the mobile robot drone system may transmit the corresponding data wirelessly.

In some embodiments, the mobile robot drone system may have an identifier that may be disposed on a housing of the robot, for example, a number or a barcode. Alternatively, the identifier may be transmitted wirelessly to a post robot or the like.

In some cases, for example, when a registered mail is delivered, a receiver signature may be required. Then, the mobile robot drone system may electronically sign documents. For example, it may wirelessly or by wires receive a receipt verification document, check the document nature, electronically sign the documents, and return the signed the document to the sender.

In some embodiments, a payment for the received nail or goods may be desired. For this purpose, the mobile robot drone system may display a payment barcode on the screen. The barcode may encode payment information of the user, for example, an account number, card holder name, expiration date, and so forth. The barcode may be scanned using a barcode scanner, and the encoded information may be retrieved to charge the account of the user.

Additionally, the mobile robot drone system may scan one or more barcodes using a camera. In such a way, the mobile robot drone system may verify the goods received via the mail and goods compartment.

When the mail or goods are received, the mobile robot drone system may deliver the mail or goods to a predefined location at operation 306. The predefined location may be specified by the user. Itinerary to the predefined location may be determined using the GPS unit and/or one or more sensors.

In some embodiments, to enable entry in locked premises, the barcode encoding electronic key data may be displayed by the mobile robot drone system (e.g. QR code). Such barcodes may be used to enter home rooms, office rooms, hotel rooms, and so forth. To enter a locked room, the mobile robot drone system may provide a key barcode displayed on screen to be scanned by a web-camera of an access control system. The barcode scanned by the web-camera may be transmitted to the access control system to retrieve the key encoded by the barcode and find the key in a database of approved keys. If the key is found in the database, the access control system may grant the user access to the room and unlock the door. Thus, the mobile robot drone system may store electronic keys for various premises, storages, and so forth allowing it to enter various premises without user assistance.

In the predefined location, the mobile robot drone system may provide access to the mail and goods compartment at operation 308. Access may be provided based on authorization. For example, the mobile robot drone system may scan face, palm, retina, fingerprint, and so forth. Alternatively, access to the mobile robot drone system may be protected by a password, a Personal Identification Number (PIN) code, a voice code, and so forth.

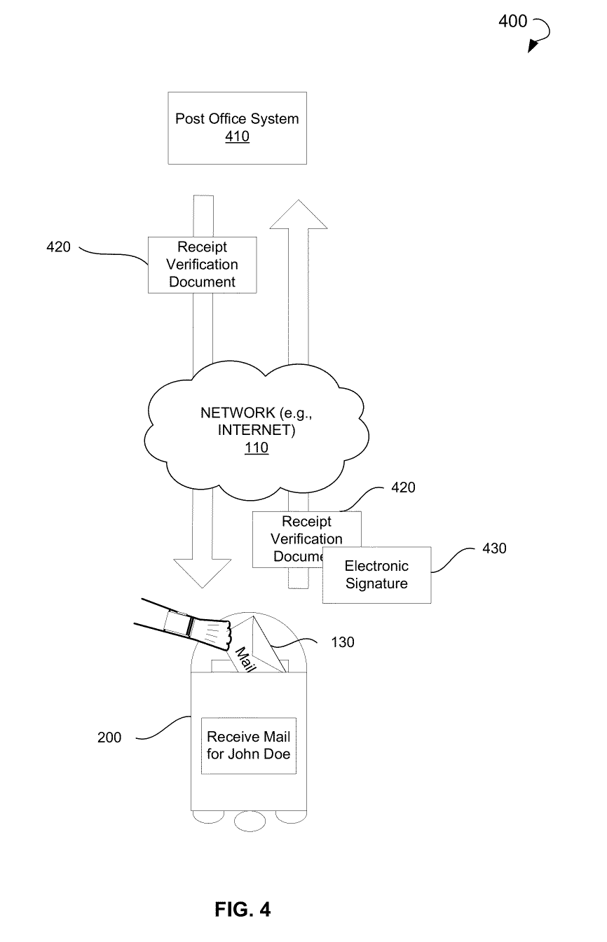

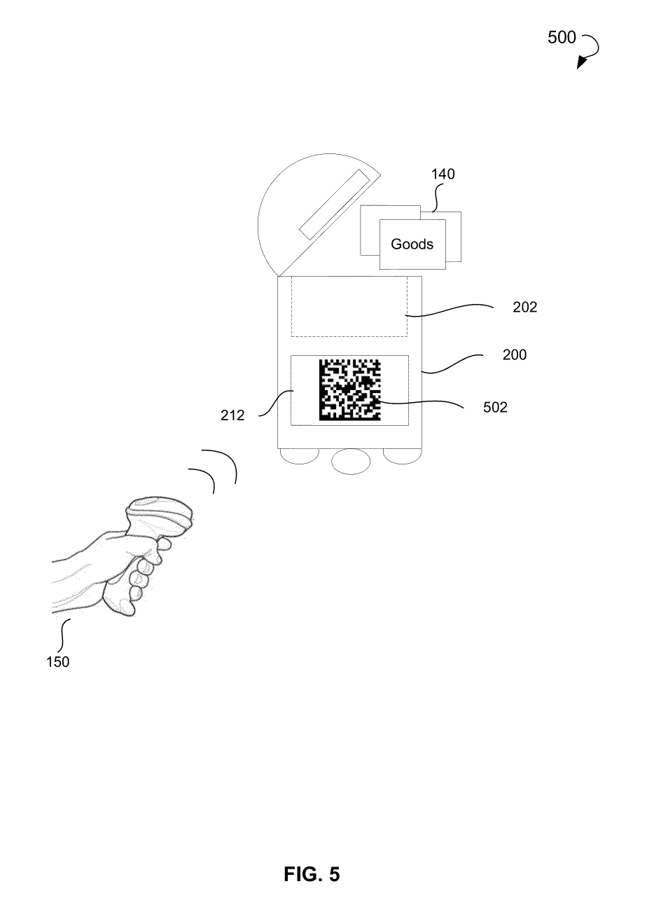

Example embodiments of method 300 will now be illustrated by FIGS. 4-5.

FIG. 4 shows the mobile robot drone system 200 receiving mail 130 with signature authorization 400, in accordance to some embodiments. A postman or another person may put mail 130 in the mail and goods compartment of the mobile robot drone system 200. The mail may require receipt verification, for example, in case of registered mail. In this case, a post office system 410 may transmit a receipt verification document 420 to the mobile robot drone system 200 over the network 110.

The mobile robot drone system 200 may receive the receipt verification document 420 and check its nature to confirm that the document 420 relates to the received mail 130. If confirmed, the mobile robot drone system 200 may electronically sign the receipt verification document 420 and transmit it back. So, the receipt verification document 420 with an electronic signature 430 may be sent back to the post office system 410.

Thus, the mobile robot drone system 200 may receive and deliver mail and goods that require signature authorization 400.

FIG. 5 shows the mobile robot drone system 200 for receiving goods 140 with barcode payment 500, in accordance to some embodiments. A salesperson or another person may put the goods 140 to a mail and goods compartment 202 of the mobile robot drone system 200.

The mobile robot drone system 200 may automatically open the lid of the mail and goods compartment 202 to provide access to it after receiving a command. For example, a person may give a command to open the mail and goods compartment 202 by pressing a button of mobile robot drone system 200. In some embodiments, access to the mail and goods compartment 202 when it is empty may be provided without authorization.

After the goods 140 are placed in the mail and goods compartment 202, the mobile robot drone system 200 may generate a payment barcode 502 encoding payment data of the user. The payment barcode 502 may be displayed on the screen 212 of the mobile robot drone system 200. The displayed barcode 502 may be scanned by a barcode scanner 150. Thus, payment data of the user may be received by the goods provider and the account associated with the payment data may be charged with the amount associated with the goods 140.

Instructions on whether to provide a payment barcode or not may be received from the user.

Therefore, the mobile robot drone system 200 may receive and deliver mail and goods that require payment.

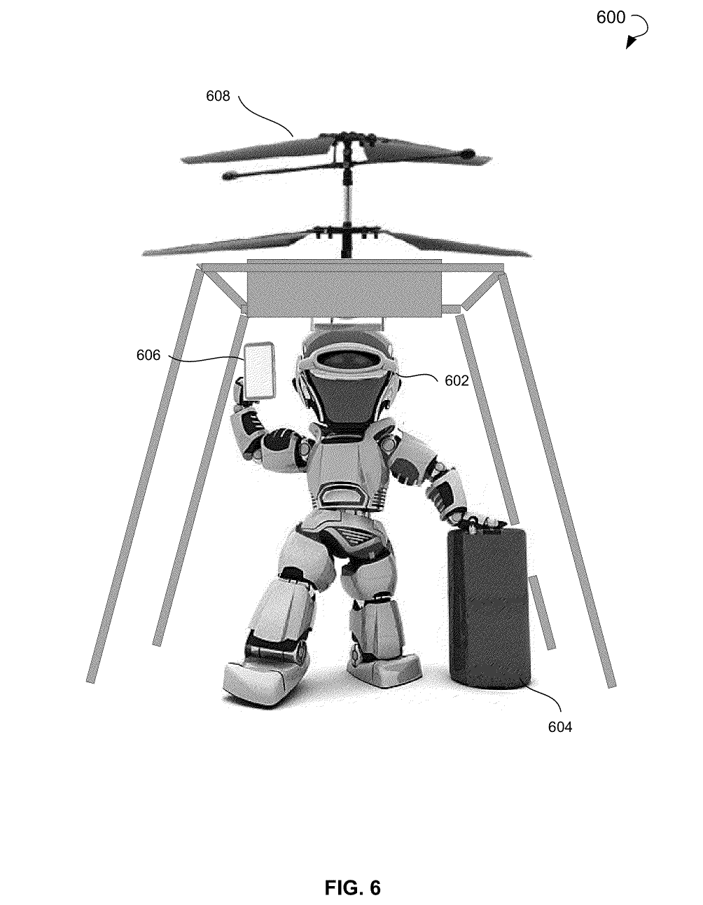

In alternative embodiments, the mobile robot drone system can include a humanoid security robot transported by a vertical take-off system, such as drone, a coaxial copter, a multicopter, and so forth. The humanoid security robot transported by drones may be used to predict and prevent crime that has a negative economic impact on the economy. An example embodiment of the mobile robot drone system 600 with the humanoid security robot is illustrated in FIG. 6. The system 600 with the humanoid security robot 602 can allow service provider to bypass existing last-mile package delivery services by delivering mail and goods over short or long distances to a destination. Delivering using the mobile robot drone system can reduce the cost of physical delivery of items in comparison to conventional human-accomplished delivery methods.

The area of the mobile robot drone system 600 uses can include express delivery of goods and mail without explicit human assistance.

In some embodiments, the mobile robot drone system 600 provides an open system architecture to support future requirements. As the mobile robot drone system 600 expands in the future, the system architecture should support it without complete restructuring.

The humanoid security robot 602 can be a mechanical agent, usually an electro-mechanical machine that is guided by a computer program or electronic circuitry. The robot 602 can be autonomous or semi-autonomous and can include a processor configured to control moving of the humanoid security robot 602 based on a geographical location of the humanoid security robot 602 and itinerary data, a memory unit communicatively coupled to the processor and configured to store at least payment data, purchase data, and the itinerary data, and a camera communicatively coupled to the processor and configured to scan a barcode, the scanning being processed by the processor to retrieve barcode information and enable payment.

A communication circuit communicatively coupled to the processor allows the robot to communicate with one or more external devices wirelessly or by wires. The processor can transmit payment data, purchase data, one or more messages of a use, etc., to be displayed by the external device. Additionally, the external device can be configured to receive a payment and transmit the payment data to the processor. A GPS module tracks geographical location of the humanoid security robot 602.

The communication circuit can provide a data link configured to provide two way communication with the mobile robot drone system either upon demand or a continuous basis. An up-link provides control of the mobile robot drone system flight path and commands to its payloads. The downlink provides both a low data rate channel to acknowledge commands and transmit status information about the mobile robot drone system and a high data rate channel for payload data such as video and radar.

For moving, the robot 602 can have one or more driving motors configured to drive the humanoid security robot and one or more legs coupled to the one or more driving motors and configured to move the humanoid security robot. The robot 602 can also have a torso and a head. The head can be adapted to replicate human facial features.

The legs can be implemented in different ways. Firstly, the robot can have two legs to imitate humans walk. However, this type is difficult to build and requires balancing circuits and devices, quick motions, and precise construction. Additionally, two legs provide low stability and can be knocked over, tripped, and so forth. Shorter, wider walkers can be used to move a large load. To improve stability, the robot can have more than two legs, for example, four legs to imitate four legged animals or six or more legs to imitate insects.

Alternatively, the robot 602 can move with the help of tracked platforms similar to tanks which ensures efficient propulsion on such surfaces as loose sand and mud, as concrete and carpet provide too much horizontal traction when turning and will strip the tracks off of their guides.

Alternatively, the robot 602 can be moved by wheeled platforms with any number of wheels. Basically there are 2 types of wheels: powered wheels and unpowered wheels. The first are powered by the motors and are used to move the robot forwards (or backwards). Unpowered wheels are used to keep the robot in balance by providing a point of contact with the ground.

In some embodiments, the robot can include ball wheels. A ball can be mounted in a casing in such a way that it can freely rotate in any direction. Two wheels around the ball are mounted against this ball at an angle of 90° to each other, parallel to the ground. One wheel registers the up-down movements and the other the left-right movements.

The ball wheel uses the same setup but connects the internal wheels to motors. This way the ball can be made to rotate in any direction. The robot 602 equipped with a ball wheel can move up-down and left-right, but cannot rotate around its vertical axis. Using three ball wheels allows rotation as well.

Turning of the robot 602 can be accomplished by way of differential steering, Ackerman steering, crab drive, 3-wheeled platforms, omnidirectional wheels, and so forth. In differential steering, one wheel is moved forward and the other backwards. The robot turns around within a small circle which center lies in between the 2 powered wheels. When one wheel is moved slower than the other, the robot turns in the direction of the slower wheel. In Ackerman steering, inner and outer wheels turn to different angles.

Each wheel can turn independently in crab drive steering. This type of steering can be very flexible, but requires complex mechanics which either turn the entire motor/gearbox/wheel assembly or transfer power from a statically mounted motor.

The three-wheeled platforms can come in a variety of forms, with the articulated wheel powered, or with the two fixed wheels powered, or a combination of the two.

The omnidirectional wheels design is based upon the use of a series of free turning barrel-shaped rollers, which are mounted in a staggered pattern around the periphery of a larger diameter main wheel. This steering type requires four powered wheels. However, these wheels allow movement in any direction without turning (including sideways and diagonal movement) and can turn the same way as in tank-like steering. One drawback, however, is the lack of sideways traction; if something is pushing the robot to the side, it relies on the strength of the motor or brakes to restrain it. Omnidirectional wheels used in place of caster wheels can provide quicker responses and can often roll over larger obstacles.

The robot 602 can include two or more arms configured to hold the mail and goods 604 and/or an external device 606. The external device can include a computing device, such as a smartphone, a tablet PC, and so forth. A receiver of the mail and goods 604 can provide payment and/or order information using the external device.

In some embodiments, the humanoid security robot 602 includes a screen, for example, a liquid crystal display, a thin-film transistor display, a touchscreen display, and so forth. The screen is configured to display one or more messages of the user, receiver, operator, system messages, and so forth.

Additionally, the humanoid security robot 602 can include one or more sensors to sense environmental parameters for the humanoid security robot 602.

The vertical take-off system or copter can be an unmanned system controlled either autonomously by onboard computers or by the remote control of a pilot or operator via a control panel on the ground or in another vehicle. The control panel can provide control and monitoring capabilities for one or more mobile robot drone systems. The typical launch and recovery method of an unmanned aircraft is by the function of an automatic system or an external operator on the ground.

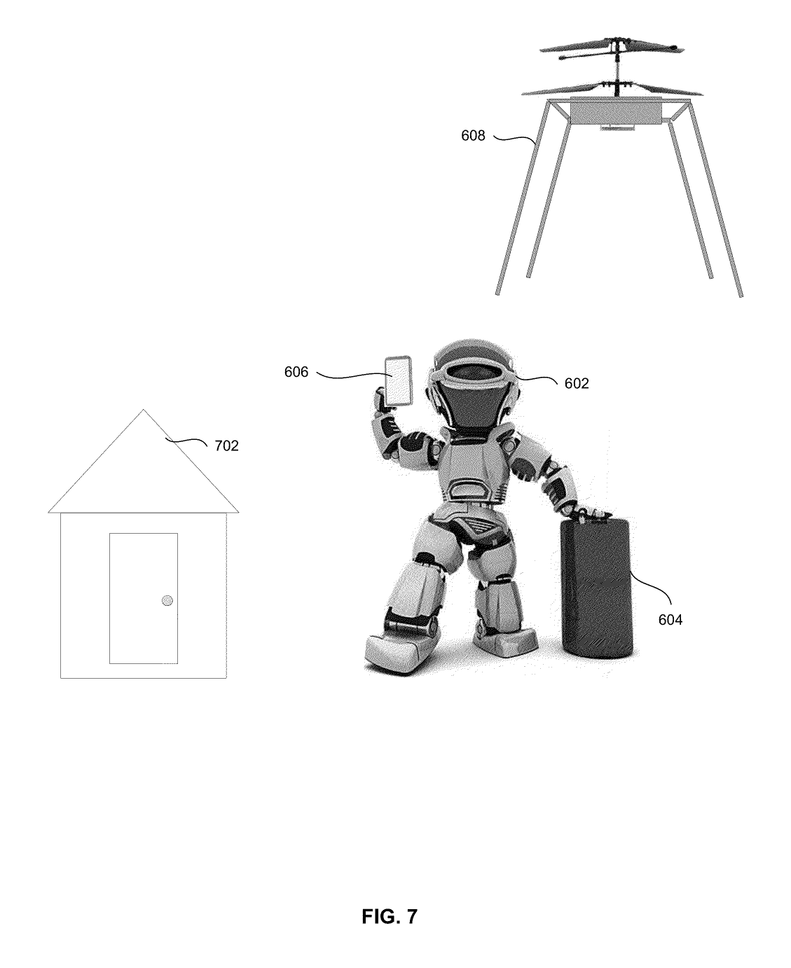

In various embodiments, the vertical take-off system or copter 608 can include various shapes, sizes, configurations, and characteristics. Thus, the copter can be a coaxial copter 608 as illustrated in FIG. 6, a quadrocopter (see FIG. 7), or another vertical take-off system.

The copter 608 is configured to transport the humanoid security robot 602 to a delivery destination and a storage facility by air and is detachably attached to the robot 602. In some embodiments, the copter 608 can include one or more supports to keep the copter 608 on the height associated with the height of the robot 602.

FIG. 7 illustrates the robot 602, when landed, unlocking from the copter 608, and moving to a house 702 of the receiver to knock the door to deliver mail and goods.

In some embodiments, when a customer orders a delivery, a cryptographic key is generated. When the mail delivery robot is deployed, it would be sent to the addresses the customer submitted. When it got to the delivery address, the customer would be able to present the robot 602 with the cryptographic key, for example, by entering it via the external device 606. The presented cryptographic key is validated and if it corresponds to the one associated with the delivery, the robot 602 unlocks the mail or goods 604 and leave it there. This will guarantee that the right customer has the package.

In some embodiments, robot 602 is configured to provide twenty-four-hour operation in a wide range of weather conditions and altitudes. Additionally, the robot 602 can be configured to enable operation beyond line-of-sight and in real time. The robot 602 can store in memory itinerary data and carry mail or goods for multiple deliveries, thus the robot 602 can perform several tasks without returning to the place of departure, e.g. a warehouse or a post office.

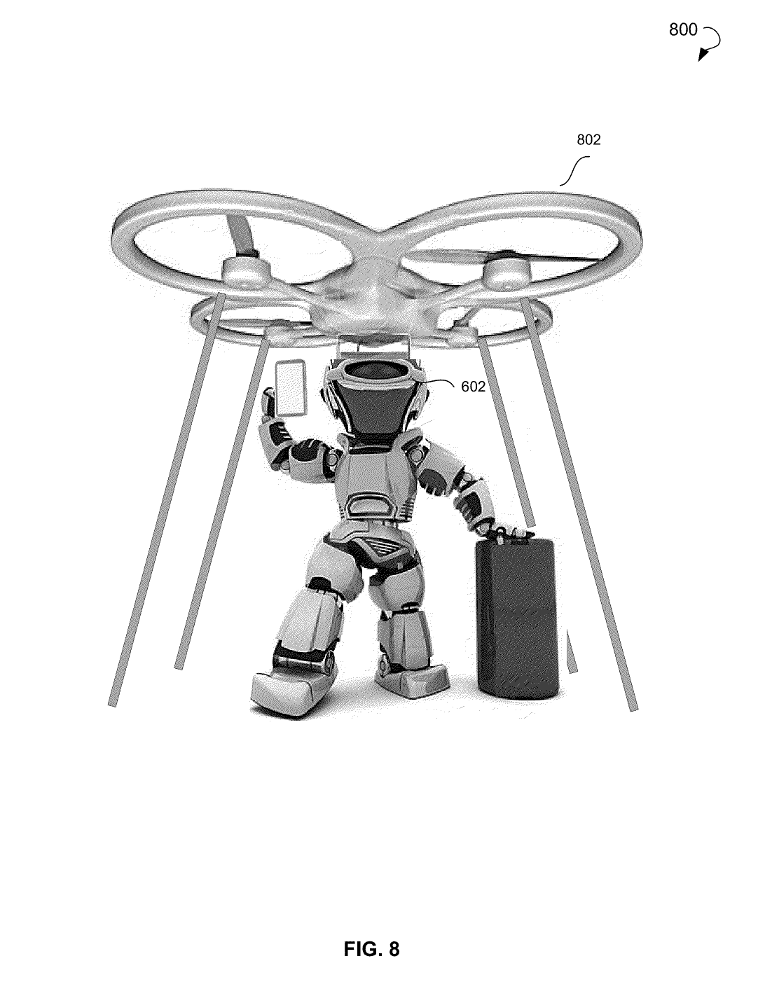

FIG. 8 shows an example embodiments of the mobile robot drone system 800 equipped with a quadcopter 802 (also referred to as quadrotor helicopter or quadrotor). The quadcopter 802 is a multicopter that is lifted and propelled by four rotors.

In some embodiments, the quadcopter 802 uses 2 sets of identical fixed pitched propellers; 2 clockwise and 2 counter-clockwise. The propellers use variation of RPM to control lift/torque. Control of vehicle motion is achieved by altering the rotation rate of one or more rotor discs, thereby changing its torque load and thrust/lift characteristic.

Though FIG. 8 illustrates the quadcopter 802 used to transport the robot 602, other types of multicopter can be used, such as hexacopter, octocopter, and so forth.

The mobile robot drone system 800 can include light materials to reduce its weight (for example, aluminum instead of steel). Building a frame out of light metal and using plastic plates as surfaces would be a lot lighter than using metal plates. For example, an acrylic plastic can be used as a material for the robot 602 and/or copter 608 or 802.

In some embodiments, the robot 602 can include a set of light-emitting diodes to signalize various states and conditions of the robot 602.

Additionally, the robot 602 can include sensors, the one or to gather real-time data to use in crime control. The gathered data can be combined with existing large data sets as well as relevant social network feeds, allowing for a breakthrough ability to map the future in a given environment. The sensors can include proprioceptive sensors, accelerometers, tilt sensors, force sensors, position sensors, infrared sensors, ultrasonic sensors, speed sensors, and so forth.

Proprioceptive sensors can sense position, orientation and speed of the robot 802. Accelerometers are used to measure acceleration, from which velocity can be calculated by integration; tilt sensors to measure inclination; force sensors placed in hands and feet to measure contact force with environment; position sensors indicate the actual position of the robot (from which the velocity can be calculated by derivation). The robot 802 needs information about contact force and its current and desired motion to maintain dynamic balance during the walk.

Arrays of tactels can be used to receive data on objects touched by the robot 802. The arrays of tactels, i.e. tactile sensors, also provide information about forces and torques transferred between the robot 802 and other objects. In an example embodiment, the robot 802 may be adapted to perform bipedal locomotion and interact with a human tool and an environment. The bipedal locomotion may be associated with a Zero Moment Point concept.

To produce an image of the surroundings, the robot 802 can have vision sensors, such as charge-coupled device (CCD) cameras. Sound sensors (e.g. microphones) allow the robot 802 to hear speech and environmental sounds, recognize objects and determine properties of the objects. Ultrasonic sensors measure speed and distances to surrounding objects.

Due to the described sensors, the robot 802 is capable of optical character recognition. The robot can converts scanned images of alphanumeric text into machine-encoded text for comparison against a defined database. Vision sensors enable omnidirectional imaging (360-degree high definition video capture), while infrared sensors provide thermal imaging.

In some embodiments, the robot 802 includes a radar and/or lidar. The radar can be used to determine the range, altitude, direction or speed of objects. Lidar measures distance by illuminating a target with a laser and analyzing the reflected light, thus providing accurate 3D mapping of the environment and specific objects.

Motion of the robot 802 can be realized by actuators. Since humanoid security robots are constructed similarly to the human body, they use actuators that perform like muscles and joints. The actuators can include electric, pneumatic, hydraulic, piezoelectric, ultrasonic, and other actuators.

Hydraulic and electric actuators have a very rigid behavior and can only be made to act in a compliant manner through the use of relatively complex feedback control strategies. While electric coreless motor actuators are better suited for high speed and low load applications, hydraulic ones operate well at low speed and high load applications.

Piezoelectric actuators generate a small movement with a high force capability when voltage is applied. They can be used for ultra-precise positioning and for generating and handling high forces or pressures in static or dynamic situations.

Ultrasonic actuators are designed to produce movements in a micrometer order at ultrasonic frequencies (over 20 kHz). They are useful for controlling vibration, positioning applications and quick switching.

Pneumatic actuators operate on the basis of gas compressibility. As they are inflated, they expand along the axis, and as they deflate, they contract. If one end is fixed, the other will move in a linear trajectory. These actuators are intended for low speed and low/medium load applications. Between pneumatic actuators there are: cylinders, bellows, pneumatic engines, pneumatic stepper motors and pneumatic artificial muscles.

The robot 802 can be used for various purposes ranging from law enforcement and security to crisis and hostage negotiation and military and special operation applications, such as policing, firefighting, and nonmilitary security work including surveillance of pipelines and missions dangerous for a manned aircraft. Furthermore, the robot 802 can be used for law enforcement to communicate with people who are threatening violence, including barricaded subjects, hostage takers, stalkers, threats, workplace violence, or persons threatening suicide. In an example embodiment, the robot 802 can be associated with autonomous technology, robotics, predictive analytics, autonomous operation, semi-autonomous operation, machine learning, and machine-to-machine communications. The robot 802 can be used for hostage negotiation including negotiation with a person and groups or persons to release one or more hostages. The robot 802 can be configured to be used as a remotely piloted aircraft. The remotely piloted aircraft can be unmanned or can have a human pilot. The remotely piloted aircraft can be controlled autonomously by onboard computers or by the remote control of a pilot. The robot 802 can be further configured as an unmanned armed combat aerial vehicle under real-time human control, according to levels of autonomy and data communication requirements.

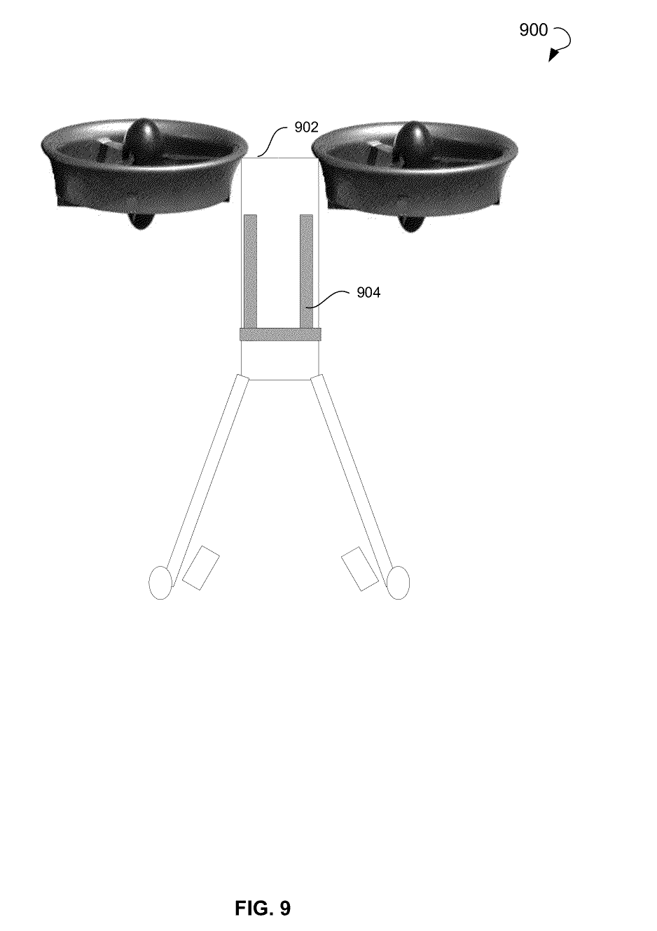

FIG. 9 shows an example personal exoskeleton 900 being a wearable personal exoskeleton heavy load flying machine, in accordance to some embodiments. The personal exoskeleton 900 can include actuating device 902 configured to move a user by air and fixing elements 904 to fix the user with the personal exoskeleton 900. Additionally, an outer framework (not shown) can be attached to the actuating device 902 to be worn by the user to increase strength and endurance of the user. The outer frame can be driven by a hydraulic system controlled by an on-board computer.

The actuating device 902 can include an internal combustion engine with at least two ducted fans to provide lift.

In order to enhance safety, the personal exoskeleton 900 can have a ballistic parachute and a fly-by-wire system whereby the user sends instructions to a processor that then interprets them and smoothly flies the craft. It can also be programmed to fly only a few meters above the ground and/or fly within certain limits.

To power the personal exoskeleton 900 an internal combustion engine, batteries or potentially fuel cells can be used. Additionally, the personal exoskeleton 900 can employ solar panels configured to power the actuating device and the outer frame for extended periods.

The personal exoskeleton 900 can be used by soldiers, nurses to carry patients, and for rehabilitation of patients, for example, after a spinal cord injury. The personal exoskeleton 900 acting as rehabilitation robots can reduce the number of therapists needed by allowing even the most impaired patient to be trained by one therapist. The personal exoskeleton 900 may assist a wearer by boosting the strength and endurance of the wearer. The personal exoskeleton 900 may be intended for military use as a robot adapted to carry heavy objects to help soldiers carry heavy loads both in and out of combat. In medical field, the personal exoskeleton 900 can be used for enhanced precision during surgery, or as an assist to allow nurses to move heavy patients. The personal exoskeleton 900 can be designed as a lightweight exoskeleton that serves as a haptic control interface for exterior appendages. The personal exoskeleton 900 can also be regarded as a wearable flying robot. The wearable flying robot may have the shape and function of the human body, with segments and joints corresponding to segments and joints of the person the personal exoskeleton 900 is externally coupled with. The wearable flying robot can be adapted to perform teleoperation, power amplification, telemanipulation, man-amplification, neuromotor control research, assistance with impaired human motor control, and so forth.

Thus, various system and methods for delivering mail and goods have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A mobile robot drone system for delivering mail and goods, the system comprising:
a mail and goods compartment including an opening to receive mail and a lid to place and remove mail and goods;
one or more driving motors configured to drive the mobile robot drone system;
moving means coupled to the one or more driving motors and configured to move the mobile robot drone system;
a processor configured to:
control moving of the mobile robot drone system based on a geographical location of the mobile robot drone system and itinerary data;
a memory unit communicatively coupled to the processor and configured to store at least payment data, purchase data, and the itinerary data;
a screen communicatively coupled to the processor and configured to graphically display one or more of the following: the payment data, the purchase data, one or more messages of the user;
a camera communicatively coupled to the processor and configured to scan a barcode, the scanning being processed by the processor to retrieve barcode information and enable payment;
a communication circuit communicatively coupled to the processor and configured to communicate with one or more external devices; and
a GPS module configured to track geographical location of the mobile robot drone system,
wherein the mobile robot drone system is operated by a remote device, wherein the remote device includes one or more of the following: a wearable personal digital wrist watch device, a wearable augmented reality eyeglass communication device, and a wearable personal digital flexible computing device,
wherein the mobile robot drone system is operated using an application associated with at least one of a mobile device and a wearable device;
wherein the mobile robot drone system is operated using a sophisticated GPS system to provide a peer-to-peer postal service;
wherein weight of the mobile robot drone system is selected from weight of less than 25 pounds, weight of 25 pounds, and weight of more than 25 pounds.

2. The mobile robot drone system of claim 1, wherein the communication circuit includes one or more of the following: a Bluetooth module, a WiFi module, a communication port, including a universal serial bus (USB) port, a parallel port, an infrared transceiver port, a radiofrequency transceiver port.

3. The mobile robot drone system of claim 1, further comprising one or more control elements to control operation or functions of the mobile robot drone system.

4. The mobile robot drone system of claim 1, further comprising one or more biometric sensors to sense biometric parameters of the user, the biometric parameters being compared to reference biometric parameters of the user to recognize the user, the reference biometric parameters being stored by the memory unit.

5. The mobile robot drone system of claim 1, wherein access to the device is controlled by one or more of the following: a password, a Personal Identification Number (PIN) code, and biometric authorization, the biometric authorization including fingerprint scanning, palm scanning, face scanning, and retina scanning, the scanning being performed using the one or more biometric sensors, wherein the fingerprint scanning is executed by fingerprint reader configured to scan a fingerprint, the scanned fingerprint being matched to one or more approved fingerprints, wherein the access to the mobile robot drone system is granted based on the matching.

6. The mobile robot drone system of claim 1, wherein the mobile robot drone system charges wirelessly using a wireless charger accessory or by means of one or more solar cells disposed on an outer surface of the mobile robot drone system.

7. The mobile robot drone system of claim 1, further comprising a microphone configured to:
sense voice data, the voice data including a voice command, a voice memo, and a voice message; and
transmit the voice data to the processor.

8. The mobile robot drone system of claim 1, further comprising an audio reproduction element configured to:
reproduce voice data, the voice data including a voice command, a voice memo, and a voice message; and
reproduce sound data, the sound data including an audio recording, a sound signal, and an alarm.

9. The mobile robot drone system of claim 1, further comprising an operating system executing on the processor, the operating system including Android, iOS, Firefox OS, and other operating systems, wherein the mobile robot drone system is compatible with one or more of the following network standards: GSM, CDMA, LTE, IMS, Universal Mobile Telecommunication System (UMTS), RFID, 4G, 5G, 6G and upper.

10. A method for delivering mail and goods using a mobile robot drone system, the mobile robot drone system comprising the mobile robot drone system of claim 1, and the method comprising:
self-moving the mobile robot drone system to a mail or goods receiving location, wherein itinerary to the mail or goods receiving location is determined based on itinerary data received from a GPS unit;
receiving the mail or goods via a mail and goods compartment;
delivering the mail or goods to a predefined location; and
providing access to the mail and goods compartment,
wherein the mobile robot drone system is configured to stand motionless as a traditional mailbox, wherein the mobile robot drone system has smart functions, humanoid functions, and smart humanoid home security functions.

11. The method of claim 10, further comprising:
providing a payment barcode on a screen, the payment barcode encoding payment information of the user, wherein the barcode is scannable by a barcode scanner; and
scanning a barcode by a camera to retrieve barcode information and enable payment.

12. The method of claim 10, further comprising:
wirelessly receiving a receipt verification document;
electronically signing the receipt verification document; and
returning the signed receipt verification document to a sender.

13. The method of claim 10, further comprising communicating with one or more external devices.

14. A mobile robot drone system for delivering mail and goods, the system comprising:
a humanoid security robot including:
one or more driving motors configured to drive the humanoid security robot;
one or more legs coupled to the one or more driving motors and configured to move the humanoid security robot;
two or more arms configured to hold the mail and goods or an external device;
a torso;
a head adapted to replicate human facial features;
a processor configured to:
control moving of the humanoid security robot based on a geographical location of the humanoid security robot and itinerary data;
a memory unit communicatively coupled to the processor and configured to store at least payment data, purchase data, and the itinerary data;
a camera communicatively coupled to the processor and configured to scan a barcode, the scanning being processed by the processor to retrieve barcode information and enable payment;
a communication circuit communicatively coupled to the processor and configured to communicate with one or more external devices; and
a GPS module configured to track geographical location of the humanoid security robot;
a copter detachably attached to the humanoid security robot, wherein the copter includes one or more supports.

15. The mobile robot drone system of claim 14, wherein the copter is a coaxial copter or a multi copter and transports the humanoid security robot to a delivery destination and a storage facility, wherein the copter is further configured to transport the humanoid security robot by air,
wherein the mobile robot drone system is configured to be used in crisis negotiation, for law enforcement to communicate with a person threatening suicide and a person threatening violence, the violence including barricaded subjects, hostage takers, stalkers, threats, workplace violence;
wherein the mobile robot drone system is configured to be used for hostage negotiation, the hostage negotiation including negotiation with a person and groups or persons to release one or more hostages.

16. The mobile robot drone system of claim 14, wherein the one or more legs include:
two or more tracked platforms configured to move the humanoid security robot; or
one or more ball wheels configured to move the humanoid security robot.

17. The mobile robot drone system of claim 14, wherein the humanoid security robot is driven using one or more of the following: a differential steering system, an Ackerman steering system, a crab drive, wherein each wheel is configured to turn independently, and one or more actuators, wherein the one or more actuators include an electric actuator, a pneumatic actuator, a hydraulic actuator, a piezoelectric actuator, and an ultrasonic actuator.

18. The mobile robot drone system of claim 14, wherein the humanoid security robot holds the external device, wherein the external device wirelessly communicates with the processor and is configured to graphically display one or more of the following: the payment data, the purchase data, and one or more messages of a user, and configured to receive a payment.

19. The mobile robot drone system of claim 14, wherein the mobile robot drone system is remotely controlled by an operator via a control panel, wherein the control panel provides control and monitoring capabilities for one or more mobile robot drone systems.

20. The mobile robot drone system of claim 14, wherein the humanoid security robot includes a screen, the screen including a liquid crystal display, a thin-film transistor display, and a touchscreen display, the screen being configured to display one or more messages, wherein the touchscreen display is configured to enable user interaction with the mobile robot drone system through touch.

21. The mobile robot drone system of claim 14, wherein the processor is further configured to:
receive, via a touchscreen display or the external device, a cryptographic key associated with the mail and goods;
validate the cryptographic key; and
based on the validation, unlock the mail and goods.

22. The mobile robot drone system of claim 14, wherein the communication circuit includes a data link, the data link being configured to provide two way communication with the mobile robot drone system.

23. The mobile robot drone system of claim 14, wherein the humanoid security robot includes one or more sensors, the one or more sensors configured to sense environmental parameters for the humanoid security robot and to gather real-time data to use in crime control and combine the real-time data with existing data sets and social network feeds, wherein the one or more sensors include one or more of the following: one or more proprioceptive sensors to sense position, orientation and speed of the humanoid security robot, one or more accelerometers, one or more tilt sensors, one or more force sensors, one or more position sensors, one or more infrared sensors, one or more ultrasonic sensors, and one or more speed sensors, wherein the one or more sensors are adapted to provide one or more of omnidirectional imaging and thermal imaging, wherein the humanoid security robot is associated with one or more of the following: autonomous technology, robotics, predictive analytics, autonomous operation, semi-autonomous operation, machine learning, and machine-to-machine communications to provide law enforcement and security to crisis negotiation and hostage negotiation and for military and special operation applications, wherein the military and special operation applications include policing, firefighting, and nonmilitary security work, wherein the nonmilitary security work includes surveillance of pipelines and missions dangerous for a manned aircraft, wherein the humanoid security robot is configured to be used as an remotely piloted aircraft, the remotely piloted aircraft being unmanned or having a human pilot, remotely piloted aircraft being controlled by one or more of the following: autonomously by onboard computers and by the remote control of a pilot;
wherein the mobile robot drone system is configured as an unmanned armed combat aerial vehicle, wherein the unmanned armed combat aerial vehicle is under real-time human control.

24. The mobile robot drone system of claim 14, wherein the humanoid security robot includes one or more arrays of tactels to receive data on objects touched by the humanoid security robot, wherein the one or more arrays of tactels are adapted to provide information about forces and torques transferred between the humanoid security robot and one or more objects;
wherein the humanoid security robot is adapted to perform bipedal locomotion and interact with a human tool and an environment, wherein the bipedal locomotion is associated with a Zero Moment Point concept.

25. The mobile robot drone system of claim 14, wherein the humanoid security robot includes one or more of the following: a vision sensor adapted to recognize objects and determine properties of the objects, a microphone, and a lidar, wherein the vision sensor includes a charge-coupled device (CCD) camera.

26. A personal exoskeleton comprising:
an actuating device configured to move by air at least a user;
an outer framework attached to the actuating device and configured to be worn by the user to increase strength and endurance of the user; and
one or more fixing elements attached to the outer framework and configured to fix the user with the outer frame.

27. The personal exoskeleton of claim 26, wherein the actuating device includes an internal combustion engine with at least two ducted fans to provide lift.

28. The personal exoskeleton of claim 26, further comprising a ballistic parachute and a fly-by-wire system to control a flight, wherein a height of the flight is limited to a predefined value.

29. The personal exoskeleton of claim 26, further comprising one or more of the following: an internal combustion engine, a battery, a fuel cell, and a solar panel configured to power the actuating device and the outer frame for extended periods.

30. The personal exoskeleton of claim 26, wherein the outer frame is driven by a hydraulic system controlled by an on-board computer, and wherein the personal exoskeleton is configured to act as one or more of the following: a rehabilitation robot, a robot adapted to carry heavy objects, a lightweight exoskeleton that serves as a haptic control interface for exterior appendages, a wearable flying robot adapted to perform one or more of teleoperation, power amplification, telemanipulation, man-amplification, neuromotor control research, and assistance with impaired human motor control.
